(19) United States
(12) Patent Application Publication
(10) Pub. No.: US 2024/0139875 A1
(43) Pub. Date: May 2, 2024

(54) METHOD OF INTERFACE SURFACE PREPARATION FOR COATED STEEL ENABLING LASER WELD OR LASER BRAZED ASSEMBLY

(71) Applicant: GM Global Technology Operations LLC, Detroit, MI (US)

(72) Inventors: Jason J. Coryell, Rochester Hills, MI (US); Mingfeng Shi, West Bloomfield, MI (US); Sarah Tedesco, Novi, MI (US); Jatinder Paul Singh, Troy, MI (US)

(21) Appl. No.: 18/049,660

(22) Filed: Oct. 26, 2022

(51) Int. Cl. B23K 26/24; B21D 28/26; B23K 26/322

(52) U.S. Cl. CPC B23K 26/24; B21D 28/26; B23K 26/322; B23K 2101/185

(57) ABSTRACT

A method of assembling a vehicle component, a system for assembling a vehicle component, and a vehicle component assembly. A blank is formed from a steel sheet, wherein the steel sheet includes a coating on a surface. The coating is removed from a first interface surface of the blank and the blank is stamped either prior to or after removing the coating. The first dynamic interface surface is arranged relative to a second interface surface and thermally joined to form a joint.

### BACKGROUND

Various coatings are used to protect steel used in vehicle assemblies from corrosion and oxidation. Two examples of such coatings include hot-dip galvanized coatings applied to sheet metals and aluminum silicon coatings. Hot-dip galvanization provides a zinc layer on the sheet steel that bonds with the iron in the steel near the interface of the zinc layer and steel. The coating protects the base steel from corrosion in services and increases abrasion resistance during stamping or other manufacturing processes. Aluminum silicon coatings provide a layer of aluminum and silicon on the surface of the steel. Aluminum silicon coatings are used on press hardening steels to protect the steel from oxidation during the hot stamping process in addition to providing corrosion resistance. However, when the coatings are present on one or both of the steel surfaces that are being welded or brazed, the coating(s) introduce impurities into the weld joint and may negatively impact the mechanical properties of the joint.

Accordingly, while the current coating technologies meets their desired objectives, room remains for the provision of methods and systems wherein the coatings are removed during the assembly process prior to welding or brazing, to ensure robust joint integrity.

### SUMMARY

According to several aspects, the present disclosure is directed to a method of assembling a vehicle component. The method includes forming a blank from a steel sheet, wherein the steel sheet includes a coating on a surface. The method further includes removing the coating from a first interface surface of the blank and stamping the blank either prior to or after removing the coating. The method also includes arranging the first interface surface relative to a second interface surface and thermally joining the first interface surface to a second interface surface to form a joint.

In embodiments of the above, the coating is one of a hot dipped galvanized (HDG) coating, an aluminum silicon (AlSi) coating, an electrogalvanized coating (EG), a hot dipped galvannealed (HDGA) coating, a zinc-aluminum-magnesium (ZnAlMg) coating, and an aluminum-zinc (AIZn) coating.

In further embodiments of the above, cutting the blank includes at least one of hydraulically cutting the blank, mechanically cutting the blank, or laser cutting the blank.

In yet further embodiments of the above, the method further includes removing the coating from the first interface surface by at least one of the following: laser ablation and mechanical abrasion.

In yet further embodiments of the above, the method further includes removing the coating from the first interface surface by mechanical abrasion, wherein mechanical abrasion includes scuffing the coating with an abrader.

In further embodiments of the above, the abrader includes one of the following: a wire brush and an abrasive.

In any of the above embodiments, the first interface surface and the second interface surface are thermally joined using at least one of the following processes: laser welding and laser brazing.

In further embodiments of the above, the blank is stamped prior to removing the coating from the first interface surface. Alternatively, the blank is stamped after removing the coating from the first interface surface.

In further embodiments of the above, the blank includes at least two pieces, and forming a blank further comprises laser welding the at least two pieces together to form the blank.

In embodiments of the above, laser welding uses a laser and removing the coating uses the laser used in laser welding the at least two pieces of the blank.

In any of the above embodiments, the method further includes uncoiling the steel sheet prior to forming the blank.

In additional embodiments of the above, the method further includes uncoiling the steel sheet prior to forming the blank, wherein the coating includes a hot dipped galvanized coating, stamping the blank after removing the coating, and thermally joining the first interface surface to a second interface surface by laser brazing the first interface surface to the second interface surface.

In further embodiments of the above, the method further includes removing the coating from the first interface surface by laser ablation or mechanical abrasion while forming the blank.

In additional embodiments of the above, the method includes uncoiling the steel sheet prior to forming a blank, coating includes an aluminum silicon coating. The method also includes laser welding at least two pieces of the steel sheet to form the blank and removing the coating from the first interface surface while laser welding the pieces of the of the steel sheet to form the blank. The method further includes stamping the blank after removing the coating and thermally joining the first interface surface to a second interface surface through laser welding.

In additional embodiments of the above, the method includes uncoiling the steel sheet prior to forming a blank, wherein the coating includes an aluminum silicon coating, stamping the blank by hot stamping before removing the coating, trimming the blank before removing the coating, and thermally joining the first interface surface to a second interface surface through laser welding.

In embodiments of the above, the method includes trimming the blank after hot stamping the blank and prior to removing the coating.

In further embodiments of the above, the method includes removing the coating from the first interface by at least one of the following processes: laser ablation and mechanical abrasion.

According to several aspects, the present disclosure also relates to a system for assembling a vehicle component. The system includes a cutter for cutting a blank from a steel sheet, the steel sheet including a coating on a surface, a coating remover for removing the coating from the blank at a first interface surface, a laser joiner for joining the first interface surface to a second interface surface, and a stamping press for stamping the blank before or after removing the coating with the coating remover.

According to several aspects, the present disclosure relates to a vehicle component assembly. The vehicle component assembly includes a first steel sheet including a coating disposed on a surface of the first steel sheet, the first steel sheet defining a first interface surface, wherein the coating is removed at the first interface surface, and wherein the first steel sheet is stamped into a configuration of the vehicle component, and a joint formed between a first interface surface and a second interface surface. The second interface surface is on one of a second steel sheet or the first steel sheet.

### BRIEF DESCRIPTION OF DRAWINGS

The present disclosure will become more fully understood from the detailed description and the accompanying drawings, wherein:

FIG. 1 illustrates a vehicle including a vehicle frame, according to embodiments of the present disclosure;

FIGS. 2A through 2F illustrate a number of joints formed through laser welding and laser brazing processes including:

FIG. 2A illustrating an edge joint;

FIG. 2B illustrating a butt joint;

FIG. 2C illustrating a lap joint;

FIG. 2D illustrating a scarf joint;

FIG. 2E illustrating a corner joint; and

FIG. 2F illustrating a joint.

FIG. 3 includes a flow chart illustrating a general method of forming a vehicle assembly, according to embodiments of the present disclosure;

FIG. 4 includes a flow chart illustrating a method of forming a vehicle assembly, according to embodiments of the present disclosure;

FIG. 5 includes a flow chart illustrating another method of forming a vehicle assembly, according to embodiments of the present disclosure; and

FIG. 6 includes a schematic illustration of a system for assembling a vehicle component, according to embodiments of the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

As used herein, the term “vehicle” is not limited to automobiles. While the present technology is described primarily herein in connection with automobiles, the technology is not limited to automobiles. The concepts can be used in a wide variety of applications, such as in connection with motorcycles, mopeds, locomotives, aircraft, marine craft, and other vehicles, as well as in other structural components and non-structural components wherein coatings are applied to steel to protect steel during the assembly of stamped steel blanks but may interfere with the joining process, weaking joints formed between one or more stamped and assembled blanks.

The present disclosure is directed to a method of assembling vehicle components including interface surface preparation of coated steel blanks during the manufacturing and assembly process. The coatings include, for example, hot dipped galvanized (HDG) coatings, aluminum silicon (AlSi) coatings, electrogalvanized coatings (EG), hot dipped galvannealed (HDGA) coatings, zinc-aluminum-magnesium (ZnAlMg) coatings, and aluminum-zinc (AlZn) coatings, or other coatings which may be detrimental to joining processes and joint integrity through the introduction of impurities, porosity or cosmetic defects. These coatings protect the steel from corrosion, oxidation, or both corrosion and oxidation during the manufacturing process and after assembly. However, the coatings interfere with joining the stamped blanks, weakening the joints. Joint interface surface preparation, removing the coating at interface surfaces, during the assembly process reduces the formation of impurities introduced by the coatings into the underlying steel at the interface upon thermal joining.

Thermal joining processes may include, for example, laser welding and laser brazing. During laser welding stamped steel blanks are joined together using a laser beam, which provides a concentrated heat source to melt the stamped blanks, joining the stamped blanks together at the weld. If not removed from one or both of the blank surfaces being joined, the coating melts or vaporizes and diffuses into the joint interface, which may reduce or alter the mechanical integrity of the joint. Vaporization may also lead to porosity and cosmetic defects. A number of joints may be formed using laser welding including butt welds, filler lap welds, overlap welds, t-butt welds, corner welds, and edge welds. During laser brazing, two or more stamped steel blanks are joined together by melting filler material, such as flux or spelter, which flows into the joint. Melting of the filler material may also melt the coating if one or both of the surface being joined include a coating, constituents of the coating may diffuse into the filler material, reducing the mechanical integrity of the joint. A number of joints may be formed using brazing including butt joints, lap joints, corner joints, and scarf joints.

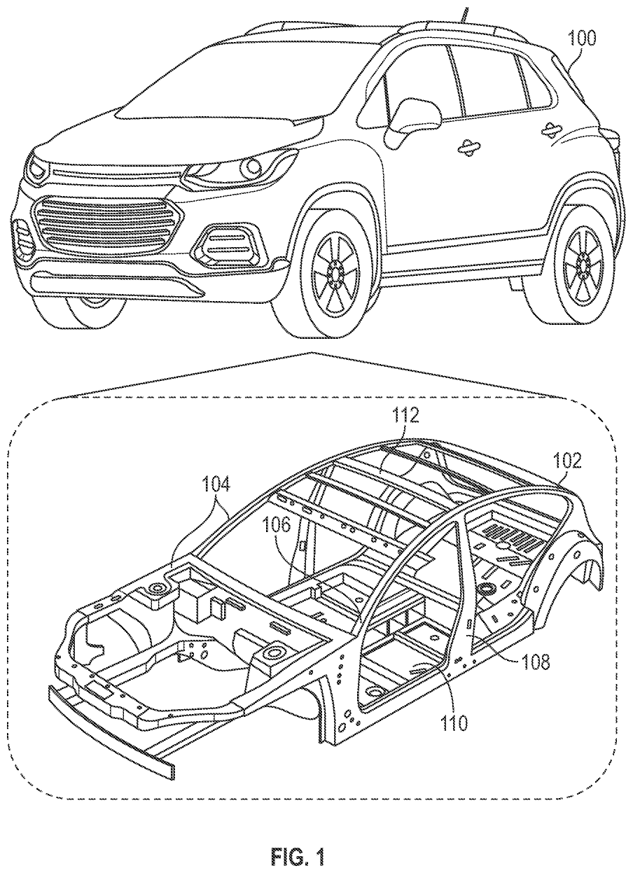

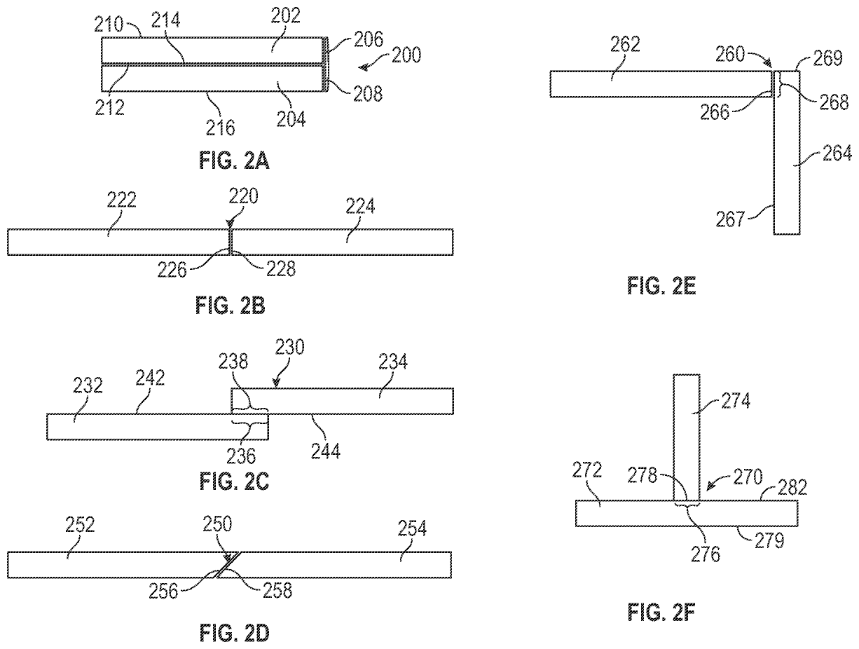

FIG. 1 illustrates a non-limiting embodiment of a vehicle 100 including a number of components, such as the body frame 102, assembled together from one or more stamped steel blanks that may be laser welded or laser brazed during the assembly processes. An assembly process is understood herein as a process including a sequence of steps where parts or materials are formed or added to form vehicle components as well as reference the component(s) produced by such processes. The several pieces 104 forming the body frame 102 include, for example, the A-pillar 106, the B-pillar 108, the floor panel 110, and the roof 112 and may be stamped from one or more blanks that are joined to form the body frame 102. The components are thermally joined at one or more interface surfaces, as illustrated in FIGS. 2A through 2F to form a joint at an interface. Interface surfaces are those surfaces that form a portion of a joint. In aspects, at least one interface surface includes a coating present on the surface, which is removed after forming the blank and prior to forming the joint. In addition to the pieces noted above, the assembly process herein may be used on numerous other components formed from at least one piece that includes a coating while the blank is being formed.

Reference is now made to FIGS. 2A through 2F, which illustrate a number of joints that may be used in the thermal joining processes described herein. FIG. 2A illustrates an edge joint 200 joining two stacked sheets 202, 204 at the end 206, 208 of each sheet 202, 204. In the illustrated embodiment, the first sheet 202 is coated and the second sheet 204 is uncoated. The sheets 202, 204 also include primary surfaces 210, 212, 214, 216. The end 206 of the first sheet 202 provides the first interface surface and the end 208 of the second sheet 204 provides the second interface surface, which are joined together to form the joint. FIG. 2B illustrates a butt joint 220 joining two adjacent, coated sheets 222, 224 at adjacent ends 226, 228 of the sheets 222, 224. The adjacent ends 226, 228 provide an interface surface. FIG. 2C illustrates a lap joint 230 joining overlapping, coated sheets 232, 234. In the region 236, 238 provide the interface surfaces, where the coatings are removed. The regions 236, 238 are located on primary surfaces 242, 244 of the sheets. FIG. 2D illustrates a scarf joint 250 joining adjacent, coated sheets 252, 254 at overlapping, adjacent ends 256, 258, which provide interface surfaces. The coatings are removed from the overlapping adjacent ends 256, 258. FIG. 2E illustrates a corner joint 260 where a first, uncoated sheet 262 is arranged at 90 degrees from a second, coated sheet 264 and the end 266 of the first sheet 262 contacts the second sheet 264 in a region 268 near an end 269 of second sheet 264. The end 266 of the first sheet 262 provides a first interface surface and the region 268 of the second sheet 264 provides a second interface surface. The region 268 of the second sheet 264 that the end 266 of first sheet 262 contacts is on a primary surface 267 of the second sheet 264. FIG. 2F illustrates a T-joint 270 where a first, coated sheet 272 is arranged at 90 degrees from a second, uncoated sheet 274 and the end 278 of the second sheet 274 contacts the first sheet 272 in a region 276 near the middle 279 of the first sheet 272. The end 278 of the second sheet 274 provides a first interface surface and the region 276 of the first sheet 272 the second sheet 274 contacts provides a second interface surface. The region 276 of the first sheet 272 that the end 278 of second sheet 274 contacts is on a primary surface 282 of the first sheet 272.

The steel used in the components and methods described herein is provided in sheet form, which, may be unrolled from a coil. In embodiments, the steel includes carbon steel, which includes iron alloyed with carbon present at 0.0001 weight percent (wt. %) to 0.5 wt. % of the total weight of the steel, along with other alloying elements including, manganese, silicon, and copper. In alternative embodiments, the steel includes ferritic grades of stainless steel, such as aluminized 409, which includes iron alloyed with at chromium present at 10 wt. % to 25 wt. % and carbon present at 0.03 wt. % to 1.0 wt. % of the total weight of the steel, as well as other alloying elements, including, at least one of manganese, phosphorus, sulfur, silicon, copper, nickel, chromium, molybdenum, tin, vanadium, columbium, titanium, aluminum, and nitrogen. In further aspects, the steel includes boron steel, which includes iron alloyed with boron present at 0.0003 wt. % to 0.004 wt. % of the total weight of the steel as well as other alloying elements such as carbon, manganese, phosphorous, sulfur, and silicon. It should be appreciated that in further alternative embodiments, other forms of steel may be used including, for example, alloy steel and advanced high strength steel.

The steel used to form at least one of the interface surfaces includes a coating, on at least one the primary surfaces. In embodiments, the coating includes at least one elemental constituent that reduces a mechanical property of the joint when present in the steel forming the joint or in the brazing filler material forming the joint. In embodiments, the coating is a hot dipped galvanized coating. Hot-dip galvanization provides a zinc layer on the steel that bonds with the iron in the steel near the interface of the zinc layer and steel. The coating protects the base steel from corrosion and increases abrasion resistance. In alternative embodiments, the coating is a hot dipped galvannealed (HDGA) coating, wherein after applying the zinc layer, the steel is annealed. In additional alternative embodiments, the coating is an aluminum silicon coating. Aluminum silicon coatings provide a layer of aluminum and silicon on the surface of the steel. Aluminum silicon coatings are used on press hardening steels to protect the steel from oxidation during the hot stamping and also provide corrosion resistance. In further alternative embodiments, the coating is a zinc-aluminum-magnesium (ZnAlMg) coating, which may exhibit improved corrosion over hot dipped galvanized coatings. In yet additional embodiments, the coating is an aluminum-zinc (AlZn) coating, which provides protection against corrosion and tarnishing. In yet further embodiments, the coatings include electrogalvanized coatings, wherein pure zinc is applied to a steel sheet through electroplating.

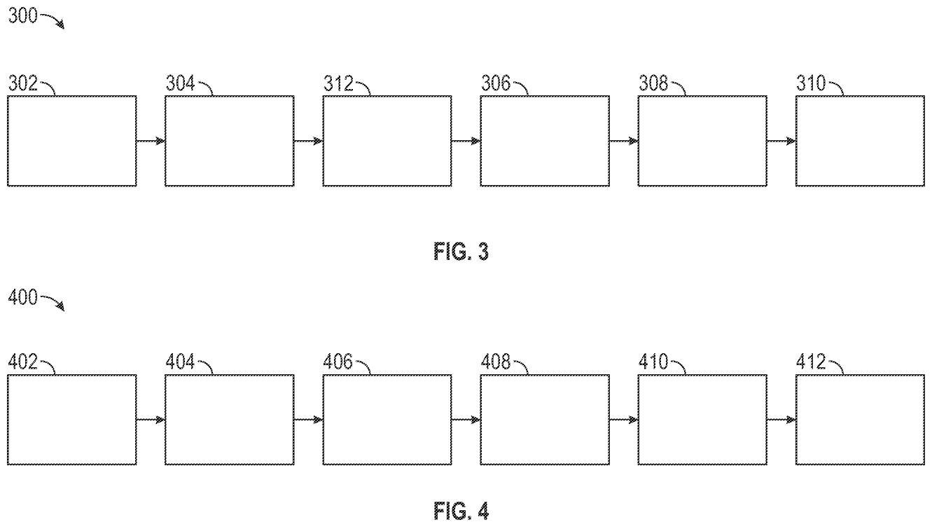

FIG. 3 illustrates a method 300 of assembling a vehicle component. Beginning at block 302 a blank is formed from a steel sheet. The primary surfaces of the steel include a coating, such as the hot dipped galvanized coating or aluminum silicon coating described above. The blank is formed by cutting the steel from the steel sheet by processes including hydraulic, mechanical and laser processes such as water jet cutting, shearing, punching, or laser cutting to provide an initial shape that will later be formed into a desired configuration by stamping. In embodiments, multiple pieces of cut steel are laser welded together, either before or after punching or laser cutting, to provide the blank. At block 304, the blank is stamped either prior to, as illustrated, or after removing the coating from the interface surface at block 306, as described further herein. The stamping process includes at least one of cold stamping or hot stamping. At block 306 the coating is removed from the blank at the interface surface. The coating is removed by laser ablation or mechanical abrasion. Laser ablation is facilitated by a laser, whereas mechanical abrasion includes the use of an abrader. An abrader includes, for example, a wire brush or an abrasive exhibiting a hardness greater than that of the coating. The abrasive may be bonded together with a binder or coated on a substrate. The coating is then scuffed by the abrader until the coated is removed. At block 308 the interface surface of the blank, i.e., the original blank or the first blank, is arranged relative to a second interface surface of one of the first blank or of a second blank. The second blank may or may not be coated. If coated, the coating is also removed from the second interface surface. At block 310 the first interface surface is thermally joined to a second interface surface. Further, in embodiments, the blank may be trimmed at block 312. In embodiments, trimming is facilitated by a hydraulic, mechanical, or laser cutting apparatus, such as waterjet, a hydraulic or mechanical press hydraulic or mechanical shears, or through the use of a laser, after the stamping process. When the blank is trimmed, the coating is removed after trimming. Various fixtures may be present for retaining the components in place during assembly operations and moving the components through the various steps of the assembly operation.

FIG. 4 illustrates an embodiment of a method 400 of assembling a vehicle component. At block 402, the steel sheet is unrolled from a coil of steel sheet. At block 404, the steel sheet is formed into a blank, such as a monolithic blank or a laser welded blank including a number of pieces laser welded together to form a single blank as described above. At block 406, the coating is removed from the interface surface of the blank through either laser ablation or mechanical abrasion. At block 408 the blank is stamped by one or more of a cold stamping process or a hot stamping process. At block 410 the interface surface (a first interface surface) of the blank, i.e., a first blank, is arranged relative to a second interface surface of the first blank or a second blank. At block 412 the first interface surface is thermally joined to the second interface surface by laser welding or laser brazing. In embodiments, components including a hot dipped galvanized coating is formed using this process. The coating is removed from an interface surface of the blank at block 406 prior to stamping the blank at block 408. Then the interface surface of the blank or two blanks are joined using laser brazing at block 412.

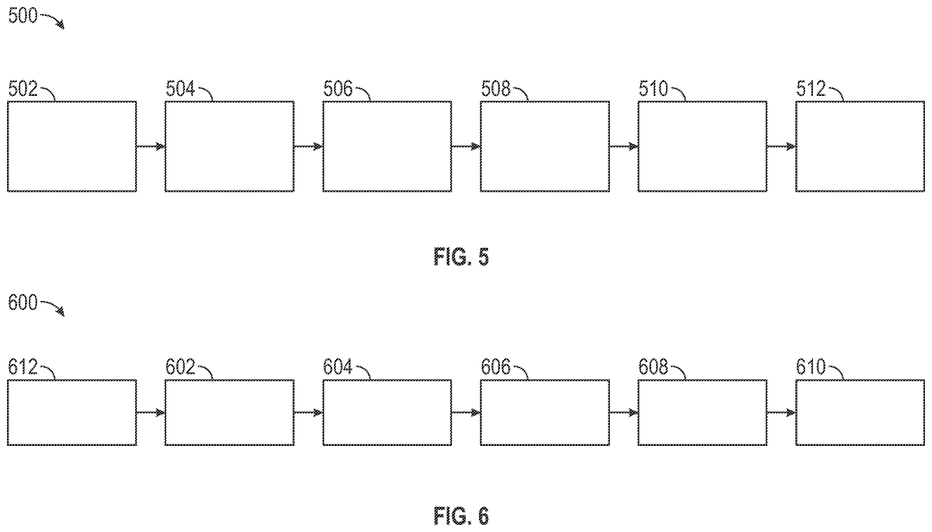

FIG. 5 illustrates an embodiment of a method 500 of assembling a vehicle component. At block 502, the steel sheet is unrolled from a coil of steel sheet. At block 504, the steel sheet is cut to form a blank, such as a monolithic blank or a laser welded blank including a number of pieces laser welded together to form a single blank as described above. At block 506 the blank is stamped by one or more of a cold stamping process or a hot stamping process. At block 508, the coating is removed from the interface surface of the blank through either laser ablation or mechanical abrasion. At block 510 the interface surface (a first interface surface) of the blank, i.e., a first blank, is arranged relative to a second interface surface of the first blank or a second blank. At block 512 the first interface surface is thermally joined to the second interface surface by laser welding or laser brazing. In embodiments, components including an aluminum silicon coating are formed using this process. At block 506, the blank is stamped prior to removing the aluminum silicon coating. In addition, as illustrated in FIG. 3, the blank is trimmed after stamping at block 312, prior to removing the coating at block 508. At block 512, the stamped blank is thermally joined using laser brazing after arranging the interface surface of the blank, i.e., the first blank, relative to another, second interface surface of a second blank or a second interface surface of the first blank.

Also provided for herein is a system for assembling a vehicle component, illustrated in FIG. 6. The system 600 includes a cutter 602 for cutting the blank. In aspects the cutter includes at least one of a mechanical, hydraulic, or laser cutting or trimming apparatus. In aspects, after cutting a laser welder 604 may be provided for joining together multiple pieces of a blank. The system further includes a coating remover 606, wherein the coating remover 606 includes at least one of a laser, for removing the coating on the steel via laser ablation, and an abrader, for removing the coating by mechanical abrasion. It should be appreciated that, in aspects, where a laser cutter 602 or laser welder 604 is used to form the steel blanks, the coating remover 606 may use the same laser for removing the coating as for cutting or welding the blanks, and thus the coating remover 606 and cutter 602 or laser welder 604 may be integrated into a single system. The system further includes a stamping press 608. The stamping press 608 may include a cold stamping press or a hot stamping press, depending on the composition of the steel being formed. Alternatively, a hydroformer may be used. As illustrated, the stamping press 608 may be located before or after the coating remover 606. The system 600 also includes a laser joiner 610, such as a laser welder, or a laser for brazing and a brazing filler feeder. The laser joiner 610 joins the blank to other components in the assembly. In embodiments of the above, the system also includes a coil unwinder 612 positioned before the cutter 602, for supporting and unwinding a coil of steel. Again, a number of fixtures may be present between the various parts of the system to facilitate movement of the blanks and components through the assembly line.

The methods described herein offer several advantages. For example, the methods described herein allows for the use of various coatings such as hot dipped galvanized steel and aluminum silicon coated steel in new applications including vehicle roof panels. Further, in aspects, the use of laser ablation and mechanical abrasion provide a “drop in” solution for laser welded blank applications, as the blanks may be ablated by the laser used in the welding process. In addition, in aspects, removing the aluminum silicon coating after hot stamping helps in reducing oxidation induced by the stamping process. Additional advantages include the reduction, and in some embodiments the elimination, of weld contamination introduced by the coatings, which contamination may weaken the laser welds of press hardened steel materials. In addition to improving weld integrity the methods provided herein also improve weld performance robustness on parts manufactured with hot dipped galvanized coated material for subsequent laser brazing and laser welding processes during assembly. A further advantage the methods herein provide includes the enablement of the use of any type of coating such as hot dipped galvanized steel, which is relatively cheaper and more widely available than other materials, in components that are prepared using laser brazing. Further, the processes described herein provide an alternative to the use of less robust and relatively expensive tri-focal laser optics heads in joining hot dipped galvanized steel.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of assembling a vehicle component, comprising:
forming a blank from a steel sheet, wherein the steel sheet includes a coating on a surface;
removing the coating from a first interface surface of the blank;
stamping the blank either prior to or after removing the coating;
arranging the first interface surface relative to a second interface surface; and
thermally joining the first interface surface to the second interface surface to form a joint.

2. The method of claim 1, wherein the coating is one of a hot dipped galvanized (HDG) coating, an aluminum silicon (AlSi) coating, an electrogalvanized coating (EG), a hot dipped galvannealed (HDGA) coating, a zinc-aluminum-magnesium (ZnAlMg) coating, and an aluminum-zinc (AIZn) coating.

3. The method of claim 2, wherein cutting the blank includes at least one of the following: hydraulically cutting the blank, mechanically cutting the blank, and laser cutting the blank.

4. The method of claim 3, further comprising removing the coating by at least one of the following: laser ablation and mechanical abrasion.

5. The method of claim 4, wherein removing the coating is by mechanical abrasion, wherein mechanical abrasion includes scuffing the coating with an abrader.

6. The method of claim 5, wherein the abrader includes at least one of the following: a wire brush and an abrasive.

7. The method of claim 4, wherein the first interface surface and the second interface surface are thermally joined using at least one of the following processes: laser welding and laser brazing.

8. The method of claim 1, wherein the blank is stamped prior to removing the coating.

9. The method of claim 1, wherein the blank is stamped after removing the coating.

10. The method of claim 1, wherein the blank includes at least two pieces, and forming a blank further comprises laser welding the at least two pieces together to form the blank.

11. The method of claim 10, wherein laser welding uses a laser and removing the coating uses the laser used in laser welding the at least two pieces of the blank.

12. The method of claim 7, further comprising uncoiling the steel sheet prior to forming the blank.

13. The method of claim 1, further comprising:
uncoiling the steel sheet prior to forming the blank, wherein the coating includes a hot dipped galvanized coating;
stamping the blank after removing the coating; and
thermally joining the first interface surface to a second interface surface by laser brazing.

14. The method of claim 13, further comprising removing the coating from the first interface surface while forming the blank, wherein removing includes at least one of: laser ablation and mechanical abrasion.

15. The method of claim 1, further comprising:
uncoiling the steel sheet prior to forming a blank, coating includes an aluminum silicon coating;
laser welding at least two pieces of the steel sheet to form the blank;
removing the coating from the first interface surface while laser welding the pieces of the of the steel sheet to form the blank;
stamping the blank after removing the coating; and
thermally joining the first interface surface to a second interface surface through laser welding.

16. The method of claim 1, further comprising:
uncoiling the steel sheet prior to forming a blank, coating includes an aluminum silicon coating;
stamping the blank by hot stamping before removing the coating;
trimming the blank before removing the coating; and
thermally joining the first interface surface to a second interface surface through laser welding.

17. The method of claim 16, further comprising trimming the blank after hot stamping the blank and prior to removing the coating.

18. The method of claim 16, wherein the coating is removed from the first interface surface by at least one of the following processes: laser ablation and mechanical abrasion.

19. A system for assembling a vehicle component, comprising:
a cutter for cutting a blank from a steel sheet, the steel sheet including a coating on a surface;
a coating remover for removing the coating from the blank at a first interface surface;
a laser joiner for joining the first interface surface to a second interface surface; and
a stamping press for stamping the blank before or after removing the coating with the coating remover.

20. A vehicle component assembly, comprising:
a first steel sheet including a coating disposed on a surface of the first steel sheet, the first steel sheet defining a first interface surface, wherein the coating is removed at the first interface surface, and wherein the first steel sheet is stamped into a configuration of a vehicle component; and
a joint formed between the first interface surface and a second interface surface,
wherein the second interface surface is on one of a second steel sheet or the first steel sheet.
